(19) United States
(12) Patent Application Publication
(10) Pub. No.: US 2003/0179542 A1
(43) Pub. Date: Sep. 25, 2003

(54) Means for externally connecting battery pack to portable computer

(75) Inventors: Chung-Chi Chien, Taipei (TW); Wu-Yung Chen, Taipei (TW); Chih-Chuan Cheng, Taipei (TW)

Correspondence Address: BACON & THOMAS, PLLC, 625 SLATERS LANE, FOURTH FLOOR, ALEXANDRIA, VA, 22314

(73) Assignee: COMPAL ELECTRONIC, INC, Taipei (TW)

(21) Appl. No.: 10/103,101

(22) Filed: Mar. 22, 2002

(51) Int. Cl. G06F 1/16

(52) U.S. Cl. 361/683

(57) ABSTRACT

A main body of a portable computer is provided at one or two lower lateral sides with at least one receiving recess, to which a battery pack is externally connected. Each battery pack includes a housing and at least one battery enclosed in the housing. The battery pack connected to the bottom of the main body downward projects from the main body to create a heat dissipation space below the main body of the portable computer and a grip area for carrying the portable computer. The portable computer may have doubled power capacity and largely extended service time when two battery packs are separately connected to two lower lateral sides thereof.

### BACKGROUND OF THE INVENTION

1. Field of the Invention

The present invention relates to means for externally connecting battery pack to portable computer, and more particularly to means for separately connecting battery packs to two lower lateral sides of a main body of a portable computer to provide a heat dissipation space below the portable computer and grip areas for conveniently carrying the portable computer.

2. Description of Prior Art

In designing a portable computer, factors that effectuate miniaturization of the computer, such as attractive appearance, high-quality structure, and compact volume, as well as factors that enable the computer to be carried in a more convenient manner, to provide longer service time, and to have good heat dissipation, must be considered at the same time.

A portable computer typically includes a main body and a monitor pivotally connected to the main body. The main body is internally provided with a central processing unit and memory or storage, and externally connected to many other peripherals, such as CD ROM and modem, so as to provide multiple functions and applications. As a common practice in designing the portable computer, a battery pack internally provided in the computer is usually particularly miniaturized to maintain the compactness of the portable computer. Such miniaturized battery pack has small capacity and therefore provides only very short service time period, forming a confusion to general users.

Moreover, the conventional portable computer does not provide any area on the main body for a user to directly carry the computer at such area. Normally, a user needs to carry the portable computer with a bag particularly designed for this purpose. In the case such bag is not available, the user would have to hold the portable computer with two hands. This is, of course, very inconvenient or even troublesome to the user.

Another problem with the portable computer known by most users is that the compact volume thereof prevents air therein from effective convection and accordingly results in poor heat dissipation of the computer. It is also known that the portable computer in use is usually directly positioned on a flat surface. Heat produced by the computer during its operation is hardly dissipated from a bottom of the computer. Therefore, it is desirable to improve the heat dissipation at the bottom of the portable computer to avoid or minimize abnormal down or damaged parts of the computer due to overheat.

### SUMMARY OF THE INVENTION

A primary object of the present invention is to provide means for externally connecting battery pack to portable computer, so that one or more battery packs are connected to lower lateral sides of the main body of the portable computer to double the capacity and service time of the computer without increasing too much volume thereof.

Another object of the present invention is to provide means for externally connecting battery pack to portable computer, so that a heat dissipation space below the main body of the computer can be provided.

A further object of the present invention is to provide means for externally connecting battery pack to portable computer, so that areas are directly provided on the portable computer for a user to grip at, enabling the portable computer to be carried in a more convenient manner.

To achieve the above and other objects, the means for externally connecting battery pack to portable computer according to the present invention mainly include at least one receiving recess provided at and parallel to one lower lateral side of a main body of the portable computer, and at least one battery pack externally connected to the receiving recess. Each battery pack includes a housing and at least one battery enclosed in the housing. The battery pack connected to the bottom of the main body downward projects therefrom to create a height difference between them, so that a heat dissipation space is formed below the main body of the portable computer. The downward projected battery pack also provides a grip area, at where the portable computer can be conveniently held. The portable computer may have doubled power capacity and largely extended service time when two battery packs are separately connected to two lower lateral sides thereof.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of the present invention;

FIG. 2 is an enlarged and partially assembled perspective view of the present invention;

FIG. 3 is an enlarged and fully assembled perspective view of the present invention; and

FIG. 4 is an assembled side view of the present invention.

### DETAILED DESCRIPTION OF THE PREFERRED EMBODIMENTS

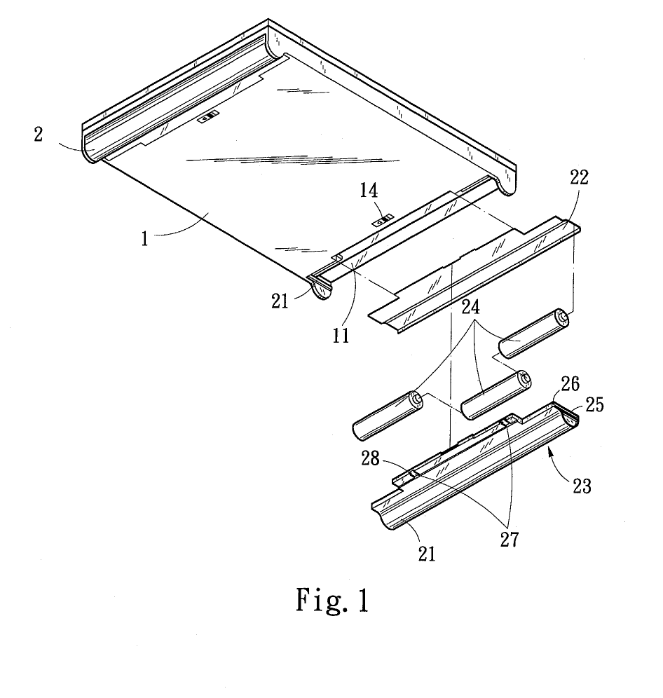

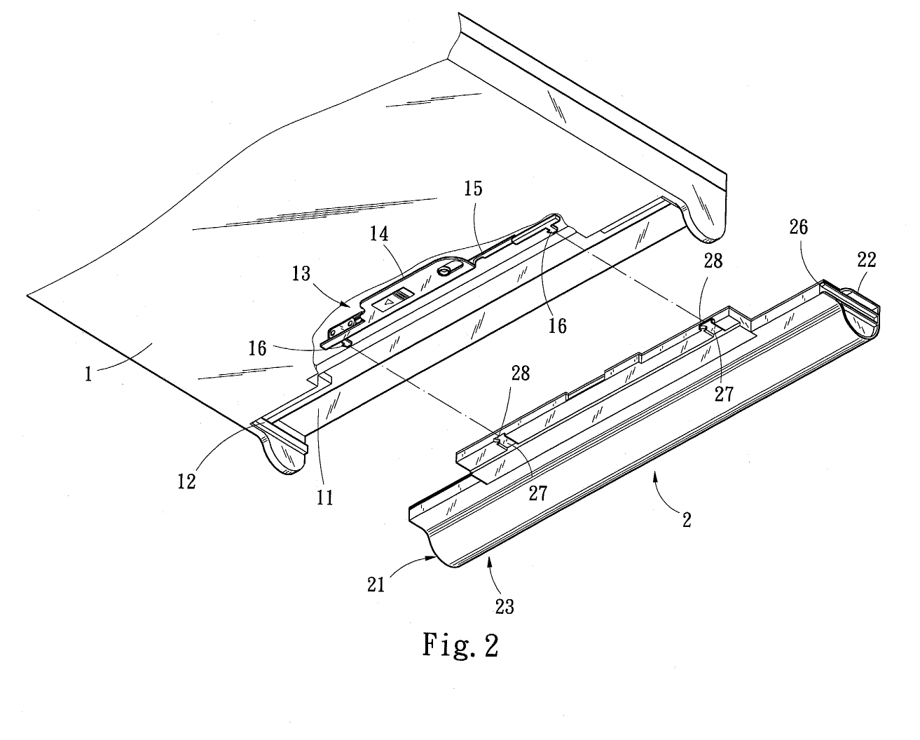

Please refer to FIGS. 1 and 2 that are exploded and partially assembled perspective views, respectively, of means for externally removably connecting a battery pack 2 to a main body 1 of a portable computer according to the present invention.

As shown, the main body 1 of the portable computer is provided at a predetermined position near at least one lateral side of a bottom surface thereof with an elongated receiving recess 11 that extends in parallel with the lateral side for connecting the battery pack 2 thereto. Two rails 12 are separately provided at two lateral ends of the receiving recess 11 to project into the receiving recess 11 by a predetermined distance. In an embodiment of the present invention, the main body 1 is provided near an inner edge of the receiving recess 11 with a holding device 13. The holding device 13 may include, for example, a transverse bar 15 provided with a push key 14 and a predetermined number of catches 16. In the illustrated embodiment, there are two catches 16 provided on the transverse bar 15. By applying a force on the push key 14, the transverse bar 15 can be laterally and reciprocatingly moved.

The battery pack 2 includes an elongate lower case 21 having an open top and a semicircular cross-sectioned bottom 23, an elongate upper case 22 for covering the open top of the lower case 21, and at least one battery 24 disposed in a space defined between the lower and the upper cases 21, 22. In the illustrated embodiment, there are three batteries 24 provided for the present invention. The lower case 21 is provided at two lateral ends with two channels 25 corresponding to and engaging with the two rails 12 projected into the receiving recess 11, so that the lower case 21 is slidable on the rails 12 relative to the main body 1. An end of each channel 25 facing toward the main body 1 defines an opening 26 via which an outer end of each rail 12 is advantageously guided into the channel 25 for easy engagement of the rail 12 with the channel 25.

The lower case 21 is provided on an inner edge at predetermined positions with slots 27 that extend in a direction perpendicularly to a longitudinal axis of the lower case 21. In the illustrated embodiment, there are two slots 27 separately corresponding to the two catches 16 of the holding device 13 on the main body 1. Each of the slots 27 is provided at a predetermined position with a retaining means 28 for holding the catch 16 of the holding device 13 thereto.

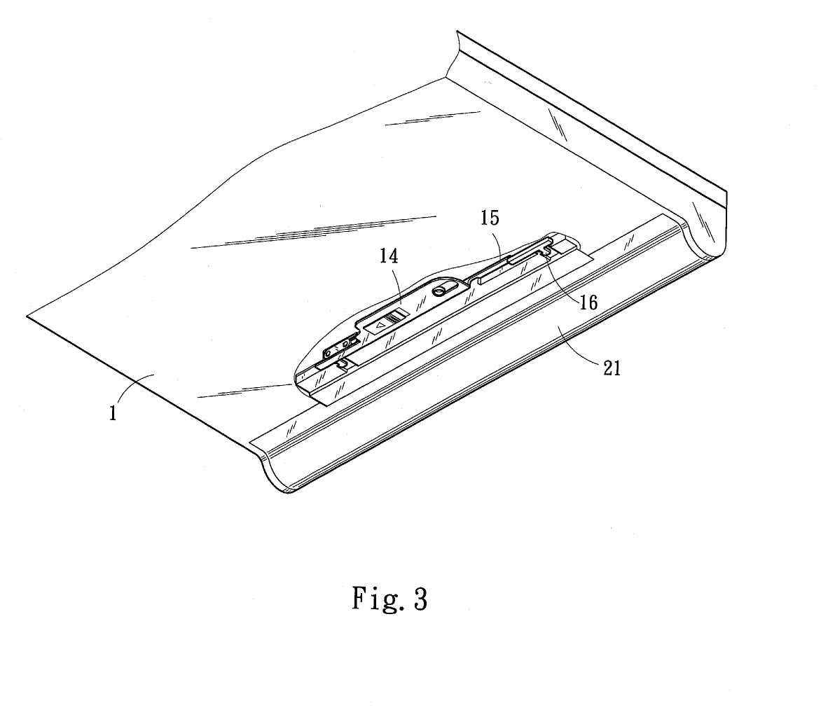

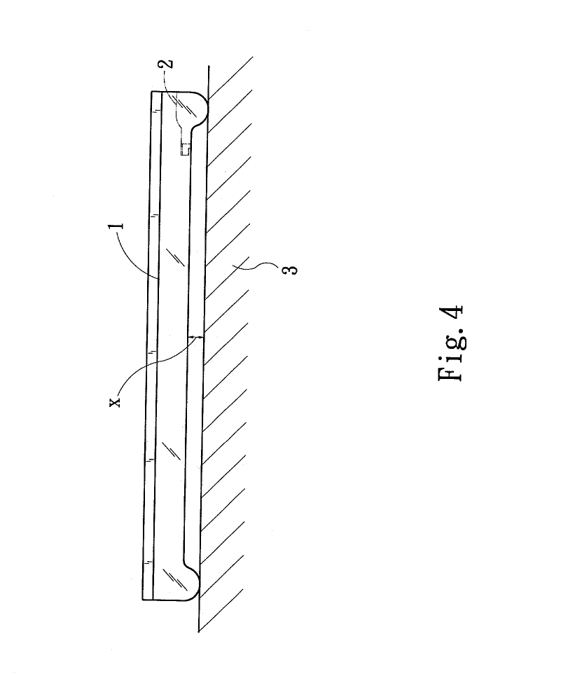

In a preferred embodiment of the present invention, the battery pack 2 is fitted in the receiving recess 11 and thereby externally connected to the main body 1 of the portable computer, as shown in FIG. 3. The semicircular bottom 23 of the lower case 21 creates a height difference between the lower case 21 and the bottom surface of the main body 1. That is, the battery pack 2 projects from the bottom surface of the main body 1 by a distance defined by the semicircular bottom 23 of the lower case 21 after the battery pack 2 is mounted to the portable computer. When the main body 1 of the portable computer is positioned on a desktop 3 or a flat surface 3 for use, the height difference defined by the battery pack 2 and the bottom surface of the main body 1 allows a fixed distance X to exist between the bottom surface of the main body 1 and the flat surface 3, as shown in FIG. 4. This fixed distance X provides a good space for heat dissipation at the bottom of the main body 1 of the portable computer. The downward projected battery pack 2 also provides an area at where a user's hand can grip to conveniently carry the portable computer without easily sliding therefrom. The user needs not to carry the portable computer with an additional bag and the like. When the portable computer is provided at two lateral sides of the bottom surface of the main body 1 with the battery packs 2, a doubled power capacity and largely extended service time can be obtained without substantially increasing an overall volume of the computer.

In brief, means for externally connecting a battery pack to a portable computer provided by the present invention have at least the following advantages:

1. It enables the portable computer to be carried without using an additional bag;

2. It enables the portable computer to have much more sufficient power capacity for use over an extended time period; and

3. It provides the portable computer with a bottom heat dissipating space.

The present invention has been described with a preferred embodiment thereof and it is understood that many changes and modifications in the described embodiment can be carried out without departing from the scope and the spirit of the invention as defined by the appended claims.

What is claimed is:

1. Means for externally connecting battery pack to portable computer, said portable computer including a main body for positioning on a flat surface for use, comprising:
at least an elongate receiving recess being provided at a predetermined position near at least one lateral side of a bottom surface of said main body of said portable computer; and
at least one battery pack being removably fitted in said at least one receiving recess; each said battery pack including a lower case, an upper case, and at least one battery received between said lower and said upper cases; said lower case having a bottom configuration that creates a height difference between said lower case and said bottom surface of said main body, so that said battery pack downward projects from said bottom surface of said main body by a fixed distance defined by said height difference after said battery pack is fitted in said receiving recess; and said fixed distance enabling a heat dissipation space to exist between said bottom surface of said main body of said portable computer and said flat surface on which said portable computer is supported.

2. Means for externally connecting battery pack to portable computer, said portable computer including a main body for positioning on a flat surface for use, comprising:
two elongate receiving recesses being separately provided at a predetermined position near each lateral side of a bottom surface of said main body of said portable computer; and
two battery packs being separately removably fitted in said elongate receiving recesses; each said battery pack including a housing and at least one battery enclosed in said housing;
whereby said portable computer with two said battery packs externally connected to said main body has doubled power capacity for use over an extended time period.

3. The means for externally connecting battery pack to portable computer as claimed in claim 1, wherein said at least one receiving recess extends in parallel with said lateral side of said main body.

4. The means for externally connecting battery pack to portable computer as claimed in claim 1, wherein each said receiving recess is provided at two lateral ends thereof with two rails that project into each said receiving recess for slidably guiding said battery pack into each said receiving recess.

5. The means for externally connecting battery pack to portable computer as claimed in claim 3, wherein each said receiving recess is provided at two lateral ends thereof with two rails that project into each said receiving recess for slidably guiding said battery pack into each said receiving recess.

6. The means for externally connecting battery pack to portable computer as claimed in claim 1, further comprising a holding device provided on said main body near an inner edge of said at least one receiving recess, and said holding device including a transverse bar provided with a push key for moving said holding device laterally and a predetermined number of catches for engaging with said at least one battery pack.

7. The means for externally connecting battery pack to portable computer as claimed in claim 6, wherein said lower case is provided at two lateral ends with two channels corresponding to and engaging with said two rails projected into said receiving recess, so that said lower case is slidable on said rails relative to said main body; and an end of each said channel facing toward said main body defining an opening via which an outer end of each said rail is easily guided into said channel; and wherein said lower case is provided on an inner edge at predetermined positions with slots separately corresponding to said catches of said holding device on said main body, and each of said slots being provided at a predetermined position with a retaining means for holding said catch of said holding device thereto.
